(19) United States
(12) Patent Application Publication
(10) Pub. No.: US 2026/0055030 A1
(43) Pub. Date: Feb. 26, 2026

(54) A CARBONATED COMPOSITE

(71) Applicant: CRH Group Services Limited, Dublin 2 (IE)

(72) Inventors: Arno KEULEN, Amsterdam (NL); Alberto BELLI, Amsterdam (NL)

(73) Assignee: CRH Group Services Limited, Dublin 2 (IE)

(21) Appl. No.: 19/106,084

(22) PCT Filed: Aug. 25, 2023
(86) PCT No.: PCT/EP2023/073371

§ 371 Date: Feb. 24, 2025

(30) Foreign Application Priority Data
Aug. 26, 2022 (NL) 2032860

(51) Int. Cl. C04B 28/08; C04B 7/147; C04B 14/06; C04B 111/00

(52) U.S. Cl. CPC C04B 28/082; C04B 7/147; C04B 14/06; C04B 2111/00019

(57) ABSTRACT

The present invention relates to a method of producing a carbonated composite:

a. providing a particulate mineral material, wherein the mineral material comprises metal slag, wherein the metal slag comprises steel slag;

b. providing a modifier, wherein the modifier comprises sodium gluconate;

c. mixing the mineral material and the modifier with water to form a slurry;

d. treating the slurry with carbon dioxide, to form a wet solid residue, wherein the concentration of carbon dioxide is greater than about 10 vol%; and

e. drying the wet solid residue to form the carbonated composite.

This invention relates to a method of producing a carbonated composite, the use of a carbonated composite, a method of producing concrete and a method of producing mortar.

### BACKGROUND TO THE INVENTION

The environmental impact of the construction industry is well known. The manufacture of Portland cement results in carbon dioxide emissions and is a leading source of carbon dioxide emissions. Portland cement is an ideal binder used in the production of concrete and mortar due to the resulting strength of the concrete and cement.

There is a need to reduce carbon dioxide emissions in the construction industry. There is a need for an efficient way to produce mortar and concrete. There is a need to make a concrete composite which has improved strength. There is a need to reduce the amount of Portland cement used in the production of mortar and cement. There is a need to maintain the strength of a concrete composite while reducing the use of Portland cement. There is a need to reuse waste products. There is a need for a product that has multiple uses.

It is, therefore, an object of the present invention to seek to alleviate the above identified problems.

### SUMMARY OF THE INVENTION

According to a first aspect of the present invention there is provided a method of producing a carbonated composite comprising:
a. providing a particulate mineral material, wherein the mineral material comprises metal slag, wherein the metal slag comprises steel slag;
b. providing a modifier, wherein the modifier comprises sodium gluconate;
c. mixing the mineral material and the modifier with water to form a slurry;
d. treating the slurry with carbon dioxide, to form a wet solid residue, wherein the concentration of carbon dioxide is greater than about 10 vol %; and
e. drying the wet solid residue to form the carbonated composite.

According to a second aspect of the present invention there is provided a use of the carbonated composite produced according to the first aspect of the invention in a method of producing mortar or concrete.

According to a third aspect of the present invention there is provided a use of the carbonated composite produced according to the first aspect of the invention a paint, a filler, a soil stabiliser, a glue, water-treatment, an aggregate or an asphalt.

According to a fourth aspect of the present invention there is provided a method of producing concrete comprising:
i. providing a supplementary cementitious material produced according to the first aspect of the invention;
ii. providing sand and an aggregate;
iii. mixing the supplementary cementitious material, the sand, and the aggregate with water to form a mixture; and
iv. curing the mixture to form concrete.

According to a fifth aspect of the present invention there is provided a method of producing mortar comprising:
A. providing a supplementary cementitious material produced as described herein
B. providing sand;
C. providing water; and
D. mixing the supplementary cementitious material, the sand, and the water to form mortar.

### DETAILED DESCRIPTION

The present invention relates to a method of producing a carbonated composite comprising:
a. providing a particulate mineral material, wherein the mineral material comprises slag, wherein the metal slag comprises steel slag;
b. providing a modifier, wherein the modifier comprises sodium gluconate;
c. mixing the mineral material and the modifier with water to form a slurry;
d. treating the slurry with carbon dioxide, to form a wet solid residue, wherein the concentration of carbon dioxide is greater than about 10 vol %; and
e. drying the wet solid residue to form the carbonated composite.

This method provides a carbon efficient method of making a carbonated composite. The method of making this carbonated composite uses carbon dioxide and stores it within the carbonated composite, this reducing carbon dioxide emissions. The carbon dioxide in the present invention can be from industry, such as flue gas from a cement or lime kiln. Surprisingly, it has been found that replacement of a proportion of Portland cement with the carbonated composite of the invention results in a concrete composite of similar or improved strength. This allows less Portland cement to be used in the production of concrete and therefore reduces the environmental impact of the resulting concrete. In a similar way, the amount of Portland cement in mortar can also be reduced. It is a further advantage that waste materials such as metal slag and ash can be reused in a productive manner. It is a particular advantage to use the method described herein to start with the particulate material and produce a carbonated composite as described herein, prior to use to make concrete. Metal slag, and in particular steel slag can comprise lime which is undesirable to include in concrete and mortar. This is because over time, the lime can absorb water which can result in cracking of the concrete or mortar and reduce the durability of the concrete or mortar. The method described herein, and in particular the carbonation step addresses this issue by reducing the amount of lime by reaction such as to form calcium carbonate. Preferably, substantially all of the lime present in the metal slag is carbonated by the method described herein.

Preferably, the weight ratio of liquid to solid (L/S) to liquid in step (c) is about 1:1 to about 10:1, preferably about 2:1 to about 6:1. Preferably, the weight ratio of liquid to solid in step (c) is about 1:1 to about 6:1, preferably about 1:1 to 2:1, preferably about 1.5:1 to about 2:1, preferably about 1.7:1 to about 2:1, preferably about 2:1. This is the ratio of the weight of the liquid to the weight of the solid. It is preferable to have as much liquid as solid, and preferably more liquid than solid to aid the mixing of the mineral material and modifier with water.

Preferably the slurry is substantially homogeneous. This aids the rate of reaction of the slurry with the carbon dioxide.

Preferably, step (c) comprises at least about 50 wt% water, preferably at least about 65 wt% water, preferably about 65 wt% to about 95 wt% water, preferably about 70 wt% to about 90 wt% water. Such amounts of water aid the mixing process. Preferably, the water comprises tap water, ground water, seawater, surface water, recycled process water or a combination of two or more thereof. It is an advantage that different sources of water can be used, including wastewater.

Preferably, the mineral material comprises Basic Oxygen Furnace (BOF) slag, Electric Arc Furnace (EAF) slag, ladle steel slag, or a combination of two or more thereof. Such materials have particular utility in the invention. It is an advantage that waste materials can be used.

Preferably, the mineral material is metal slay, preferably the mineral material is steel slag, preferably, the mineral material is Basic Oxygen Furnace (BOF) slag, Electric Arc Furnace (EAF) slag, ladle steel slag, or a combination of two or more thereof.

Preferably, the mineral material further comprises fly ash, bottom ash, belite cement, Portland cement, Portland clinker, concrete fines, air pollution control residue, cement bypass dust, lime bypass dust or a combination of two or more thereof. These additional mineral materials can also be used in the present invention.

Preferably, the mineral material further comprises concrete fines, air pollution control residue, cement bypass dust, lime bypass dust or a combination of two or more thereof. These additional mineral materials can also be used in the present invention.

Preferably, the mineral material comprises calcium silicate, dicalcium silicate, tricalcium silicate, iron silicate, calcium oxide, calcium hydroxide, calcium silicate hydrate or a combination of two or more thereof. Such compounds may be carbonated by carbon dioxide.

Preferably, the particulate mineral material has a D50 particle size of about 1 μm to about 5 mm, preferably about 2 μm to about 500 μm, preferably about 3 μm to about 100 μm. These sizes balance the need to be easy to handle with having a large surface area to be carbonated. Furthermore, the resultant carbonated composite has a substantially similar size, and this allows the carbonated composite to be used, such as to make concrete.

Preferably, step a comprises grinding the particulate material, preferably wet or dry grinding the particulate material, preferably wet grinding the particulate material. This allows an appropriately sized particulate material to be formed. An advantage of wet grinding is that this reduces the amount of water that needs to be added to form the slurry.

Preferably, step (c) comprises about 2 wt % to about 45 wt % mineral material, preferably about 5 wt % to about 30 wt % mineral material, preferably about 10 wt % to about 25 wt % mineral material. This allows the mineral material to be mixed with the modifier and water.

An advantage of using sodium gluconate is that it retards the hydration reaction rate of the particulate mineral material and gives better control of the process. This allows a more uniform carbonated composite to be produced and makes the reaction more predictable. As a result, a larger amount of carbon dioxide can be captured in the carbonation step. This further makes the process more environmentally friendly. This is particularly important when the particulate material comprises cement, preferably belite cement.

Further, the presence of sodium gluconate in the carbonated composite means that less water is required when concrete or mortar is produced using the carbonated composite which in turn makes the concrete or mortar harder and have a higher compressive strength. Further, surprisingly, the use of sodium gluconate for the production of the carbonated composite of the invention in the production of mortar or concrete optimises the rate of hydration and results in concrete or mortar with a higher compressive strength. It is surprising that including sodium gluconate in the carbonated composite has this technical effect.

The sodium gluconate therefore has the dual advantage of improving the method of making a carbonated composite, and of making concrete or mortar using the carbonated composite by requiring less water and, further results in concrete or mortar with higher compressive strength.

Surprisingly, using sodium gluconate in the slurry results in an improved carbonated composite which can be used as a partial replacement of Portland cement in a method of making concrete. Without being bound by theory, it is believed that the water present in the slurry aids the distribution of the modifier throughout the slurry leading to a more homogeneous mixture, which in turn leads to a more uniform carbonated composite. This allows the carbonated composite to be used as a replacement for Portland cement. The treatment of a slurry with carbon dioxide is important for this process.

Preferably, step (c) comprises about 0.01 wt % to about 3 wt % modifier, based on the weight of the particulate material, preferably about 0.01 wt % to about 2 wt % modifier, based on the weight of the particulate material, preferably about 0.1 wt % to about 1 wt % modifier, based on the weight of the particulate material, preferably about 0.3 wt% to about 0.8 wt % modifier, based on the weight of the particulate material. Such amounts are shown to improve the strength of a resulting concrete composite using the carbonated composite.

Preferably, the carbonated composite is particulate. Preferably, the carbonated composite has a D50 particle size of about 1 μm to about 5 mm, preferably about 2 um to about 500 um, preferably about 3 μm to about 100 um. Such sizes can be used as a carbonated composite in a method of making concrete or cement.

Preferably, the carbonated composite is a supplementary cementitious material.

Preferably, the supplementary cementitious material is particulate. Preferably, the supplementary cementitious material has a D50 particle size of about 1 μm to about 5 mm, preferably about 2 μm to about 500 μm, preferably about 3 μm to about 100 μm Such sizes can be used as a carbonated composite in a method of making concrete or cement.

The average particle size may be measured by laser diffraction or sieving, preferably by laser diffraction.

Preferably, step (e) comprises heating, filtering, centrifuging, air drying or a combination thereof. Preferably the slurry is filtered and then heated to form the carbonated composite.

Preferably, the water removed in step (e) is recycled for use in the method. This reuse is environmentally friendly.

Preferably, the method further comprises:
f. granulating, grinding, crushing, pelletizing or extruding the carbonated composite, preferably grinding the carbonated composite, preferably wherein the particle size of the carbonated composite is about 3 μm to about 100 μm.

This step allows the desired particle size to be achieved. Often, the carbonated composite can be in the form of a cake after drying step (e) and further processing can achieve the required particle size.

Preferably, the concentration of carbon dioxide is about 10 vol % to about 100 vol %, preferably about 40 vol % to about 90 vol %, preferably about 50 vol % to about 80 vol %, preferably about 50 vol % to about 70 vol %. Such concentrations are suitable for the carbonation step. It will be appreciated that the concentration of carbon dioxide refers to the amount of carbon dioxide supplied in the treatment step, such as the concentration of the carbon dioxide in the gas.

### Preferably, the Carbon Dioxide Is Flue Gas. This Allows Efficient Use of a Waste Product.

Preferably, the carbon dioxide is piped in or from a tank. The carbon dioxide is preferably flue gas piped from a plant. These are suitable ways of providing the carbon dioxide.

Preferably, the carbon dioxide is dissolved in the water. This allows efficient carbonation of the mineral material.

Preferably, the carbon dioxide is directly introduced into the slurry, preferably the carbon dioxide is piped into the slurry. This can increase the rate of carbonation.

Preferably, about 5 wt % to about 30 wt % carbon dioxide based on the weight of the particulate material is captured in step d, preferably about 10 wt % to about 20 wt% carbon dioxide, most preferably about 15 wt % to about 20 wt % carbon dioxide. It is an advantage that such an amount of carbon dioxide can be captured in step d, the carbonation step, as it makes the process more environmentally friendly. Further the carbonation step reduces the amount of lime present in the carbonated composite which increases the durability of the concrete or mortar made using the carbonated composite as described above.

Preferably, the method is carried out at a temperature of up to about 150° C., preferably about 10 to about 150° C., preferably about 15° C. to about 70° C., preferably about 20° C. to about 50° C. Such temperatures allow for an efficient reaction. Preferably the temperature in step c or step d are each independently up to about 150° C., preferably about 10 to about 150° C., preferably about 15° C. to about 70° C., preferably about 20° C. to about 50° C.

Preferably, the water is provided at a temperature of about 1° C. to about 20° C. The reaction is exothermic, therefore preferably, the reaction is cooled to the preferred temperature.

Preferably, steps c and d are carried out in a reactor. Preferably, steps c and d comprise rotating the reactor, preferably at a speed of up to about 2000 rotations/minute, preferably about 1000 to about 1500 rotations per minute. This increases the speed of reaction by ensuring efficient mixing.

Preferably, the method is carried out at a pressure of about 0 to about 10 bar, preferably about 1 to about 3 bar, preferably about 2 bar. It is an advantage that increasing the pressure decreases the reaction time.

Preferably, step d is carried out for a period of about 20 minutes to about 1 hour, preferably about 30 minutes to about 45 minutes. Such times are suitable for carrying out the carbonation step.

Preferably, the carbonated composite has a D50 particle size of about 1 μm to about 5 mm, preferably about 2 μm to about 500 um, preferably about 3 μm to about 100 μm; and

wherein step (c) comprises at least about 65% water, preferably about 65 wt % to about 95 wt % water, preferably about 70 wt % to about 90 wt % water. It is an advantage that such particle sizes can be used as a carbonated composite in a method of making concrete or cement. It is an advantage that such an amount of water aids the mixing process.

Preferably, the carbonated composite has a D50 particle size of about 1 μm to about 5 mm, preferably about 2 μm to about 500 μm, preferably about 3 μm to about 100 μm; and

wherein the weight ratio of liquid to solid (L/S) to liquid in step (c) is about 1:1 to about 2:1, preferably about 1.5:1 to about 2:1, 1:7 to about 2:1, preferably about 2:1. It is an advantage that such particle sizes can be used as a carbonated composite in a method of making concrete or cement. It is preferable to have as much liquid as solid, and preferably more liquid than solid to aid the mixing of the mineral material and modifier with water.

The present invention relates to the use of the carbonated composite produced as described herein in a method of producing mortar or concrete. The carbonated composite can be used as a partial replacement for Portland cement.

Preferably, the carbonated composite is a supplementary cementitious material.

The present invention relates to the use of the carbonated composite produced as described herein in a paint, a filler, a soil stabiliser, a glue, water-treatment, an aggregate or an asphalt. It is an advantage that the carbonated composite can have multiple end uses.

The present invention relates to a method of producing concrete comprising:
i. providing a carbonated composite produced as described herein;
ii. providing sand and an aggregate;
iii. mixing the supplementary cementitious material, the sand, and the aggregate with water to form a mixture; and
iv. curing the mixture to form concrete.

Surprisingly, the use of the carbonated composite of the present invention leads to improved strength properties of the resulting concrete.

Preferably, the aggregate has an average particle size of about 1 mm to about 60 mm, preferably about 5 mm to about 40 mm. Such sizes are suitable for forming concrete. Preferably the aggregate comprises gravel.

Preferably the sand has an average particle size of less than about 4 Mm.

Preferably, step i further comprises providing Portland cement, wherein the weight ratio of the Portland cement to the carbonated composite is in the range of about 10:1 to about 1:1, preferably about 5:1 to about 3:1. This balances the need for the strength of concrete or cement with the desire to use less Portland cement.

Surprisingly, the carbonated composite of the present invention can be used as a direct replacement of Portland cement. The examples indicate that the concrete will have improved strength compared to a sample with only Portland cement.

The present invention relates to a method of producing mortar comprising:
A. providing a supplementary cementitious material produced as described herein;
B. providing sand;
C. providing water; and
D. mixing the supplementary cementitious material, the sand and the water to form mortar.

Preferably, step A further comprises providing Portland cement, wherein the weight ratio of the Portland cement to the carbonated composite is in the range of about 10:1 to about 1:10, preferably up to 1:8, preferably about 9:1 to about 1:1. This balances the need for the strength of the cement with the desire to use less Portland cement. Surprisingly, the carbonated composite of the present invention can be used as a direct replacement of Portland cement. The examples show that the cement will have improved strength compared to a sample with only Portland cement.

The present invention may be described in accordance with the following clauses:

1) A method of producing a carbonated composite comprising:
a. providing a particulate mineral material, wherein the mineral material comprises metal slag, ash, cement, or a combination of two or more thereof;
b. providing a modifier, wherein the modifier comprises sodium gluconate;
c. mixing the mineral material and the modifier with water to form a slurry;
d. treating the slurry with carbon dioxide, to form a wet solid residue, wherein the concentration of carbon dioxide is greater than about 10 vol %; and drying the wet solid residue to form the carbonated composite, preferably wherein the carbonated composite is a supplementary cementitious material.

2) A method according to clause 1, wherein the weight ratio of liquid to solid (L/S) to liquid in step (c) s about 1:1 to about 10:1, preferably 1:1 to about 6:1, preferably about 1:1 to 2:1, preferably about 1.5:1 to about 2:1, preferably about 1.7:1 to about 2:1, preferably about 2:1. ; and/or
wherein step (c) comprises at least about 50 wt % water, preferably at least about 65 wt % water, preferably about 65 wt % to about 95 wt % water, preferably about 70 wt % to about 90 wt % water.

3) A method according to any preceding clause, wherein the mineral material comprises metal slag, fly ash, bottom ash, belite cement, Portland cement, Portland clinker, or a combination of two or more thereof; preferably metal slag or belite cement, preferably metal slag, preferably steel slag, preferably Basic Oxygen Furnace (BOF) slag, Electric Arc Furnace (EAF) slag, ladle steel slag, or a combination of two or more thereof.

4) A method according to any preceding clause, wherein the mineral material further comprises concrete fines, air pollution control residue, cement bypass dust, lime bypass dust or a combination of two or more thereof.

5) A method according to any preceding clause, wherein the particulate mineral material has a D50 particle size of about 1 μm to about 5 mm, preferably about 2 um to about 500 μm, preferably about 3 μm to about 100 μm; and/or wherein step (c) comprises about 2 wt % to about 45 wt % mineral material, preferably about 5 wt % to about 30 wt % mineral material, preferably about 10 wt% to about 25 wt % mineral material.

6) A method according to any preceding clause, wherein the modifier comprises sodium gluconate; and/or
wherein step (c) comprises about 0.01 wt % to about 3 wt % modifier, based on the weight of the particulate material, preferably about 0.01 wt % to about 2 wt% modifier, based on the weight of the particulate material, preferably about 0.1 wt% to about 1 wt % modifier, based on the weight of the particulate material, preferably about 0.3 wt % to about 0.8 wt % modifier, based on the weight of the particulate material.

7) A method according to any preceding clause, wherein the supplementary cementitious material is particulate, preferably wherein the supplementary cementitious material has a D50 particle size of about 1 μm to about 5 mm, preferably about 2 μm to about 500 μm, preferably about 3 μm to about 100 μm.

8) A method according to any preceding clause, further comprising
e. granulating, grinding, crushing, pelletizing or extruding the carbonated composite, preferably grinding the carbonated composite.

9) A method according to any preceding clause, wherein the concentration of carbon dioxide is about 10 vol % to about 100 vol %, preferably about 40 vol % to about 90 vol %, preferably about 50 vol % to about 80 vol %, preferably about 50 vol % to about 70 vol %.

10)A method according to any preceding clause, wherein the method is carried out at a temperature of up to about 150° C., preferably about 10 to about 150° C., preferably about 15° C. to about 70° C., preferably about 20° C. to about 50° C. ; and/or
wherein the method is carried out at a pressure of about 0 to about 10 bar, preferably about 1 to about 3 bar, preferably about 2 bar; and/or wherein steps c and d are carried out in a reactor, preferably, steps c and d comprise rotating the reactor, preferably at a speed of up to about 2000 rotations/minute, preferably about 1000 to about 1500 rotations per minute.

11)A method according to any preceding clause, wherein about 5 wt % to about 30 wt % carbon dioxide based on the weight of the particulate material is captured in step d, preferably about 10 wt % to about 20 wt % carbon dioxide, most preferably about 15 wt % to about 20 wt % carbon dioxide.

12)A method according to any preceding clause, wherein the carbonated composite has a D50 particle size of about 1 μm to about 5 mm, preferably about 2 μm to about 500 μm, preferably about 3 μm to about 100 μm; and wherein step (c) comprises at least about 65% water, preferably about 65 wt % to about 95 wt % water, preferably about 70 wt % to about 90 wt % water;
preferably wherein the particulate material comprises metal slag, preferably steel slag.

13)A method according to any preceding clause, wherein the carbonated composite has a D50 particle size of about 1 μm to about 5 mm, preferably about 2 μm to about 500 μm, preferably about 3 μm to about 100 μm; and
the weight ratio of liquid to solid (L/S) to liquid in step (c) is about 1:1 to about 2:1, preferably about 1.5:1 to about 2:1, 1:7 to about 2:1, preferably about 2:1;
preferably wherein the particulate material comprises metal slag, preferably steel slag.

14)A method according to any preceding clause, wherein step d is carried out for a period of about 20 minutes to about 1 hour, preferably about 30 minutes to about 45 minutes.

15) Use of the carbonated composite produced according to any preceding clause in a method of producing mortar or concrete.

16) Use of the carbonated composite produced according to any of clauses 1 to 14 in a paint, a filler, a soil stabiliser, a glue, water-treatment, an aggregate or an asphalt.

17)A method of producing concrete comprising:
i. providing a supplementary cementitious material produced according to any of clauses 1 to 14;
ii. providing sand and an aggregate;
iii. mixing the supplementary cementitious material, the sand, and the aggregate with water to form a mixture; and
iv. curing the mixture to form concrete.

18)A method according to clause 17, wherein step i further comprises providing Portland cement, wherein the weight ratio of the Portland cement to the carbonated composite is in the range of about 10:1 to about 1:1, preferably about 5:1 to about 3:1.

19)A method of producing mortar comprising
A. providing a supplementary cementitious material produced according to any of clauses 1 to 14;
B. providing sand;
C. providing water; and mixing the supplementary cementitious material, the sand, and the water to form mortar.

Within this specification embodiments have been described in a way which enables a clear and concise specification to be written, but it is intended and will be appreciated that embodiments may be variously combined or separated without parting from the invention. For example, it will be appreciated that all preferred features, claims and clauses described herein are applicable to all aspects of the invention described herein and vice versa.

Within this specification, the term “about” means plus or minus 20%, more preferably plus or minus 10%, even more preferably plus or minus 5%, most preferably plus or minus 2%.

Within this specification, the term “substantially” means a deviation of plus or minus 20%, more preferably plus or minus 10%, even more preferably plus or minus 5%, most preferably plus or minus 2%.

Within this specification, reference to “substantially” includes reference to “completely” and/or “exactly”. That is, where the word substantially is included, it will be appreciated that this also includes reference to the particular sentence without the word substantially.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications are covered by the appended claims.

1. A method of producing a carbonated composite comprising:
a. providing a particulate mineral material, wherein the particulate mineral material comprises metal slag, wherein the metal slag comprises steel slag;
b. providing a modifier, wherein the modifier comprises sodium gluconate;
c. mixing the mineral material and the modifier with water to form a slurry;
d. treating the slurry with carbon dioxide, to form a wet solid residue, wherein the concentration of carbon dioxide is greater than about 10 vol %; and
e. drying the wet solid residue to form the carbonated composite.

2. The method according to claim 1, wherein the weight ratio of liquid to solid (L/S) in step (c) is about 1:1 to about 10:1.

3. The method according to claim 1, wherein the particulate mineral material comprises Basic Oxygen Furnace (BOF) slag, Electric Arc Furnace (EAF) slag, ladle steel slag, or a combination of two or more thereof.

4. (canceled)

5. The method according to claim 1, wherein the particulate mineral material has a D50 particle size of less than about 5 mm.

6. (canceled)

7. The method according to claim 21, wherein the supplementary cementitious material has a D50 particle size of about 1 μm to about 5 mm.

8. The method according to claim 1, further comprising granulating, grinding, crushing, pelletizing, or extruding the carbonated composite.

9. The method according to claim 1, wherein the concentration of carbon dioxide is about 10 vol % to about 100 vol %.

10. The method according to claim 1, wherein about 5 wt % to about 30 wt % carbon dioxide based on the weight of the particulate material is captured in step d.

11. (canceled)

12. (canceled)

13. (canceled)

14. (canceled)

15. (canceled)

16. (canceled)

17. A method of producing concrete comprising:
a. providing a carbonated composite produced according to claim 1;
b. providing sand and an aggregate;
c. mixing the carbonated composite, the sand, and the aggregate with water to form a mixture; and
d. curing the mixture to form concrete.

18. The method according to claim 17, wherein step i further comprises providing Portland cement, wherein the weight ratio of the Portland cement to the carbonated composite is in the range of about 10:1 to about 1:1.

19. A method of producing mortar comprising
a. providing a carbonated composite produced according to claim 1;
b. providing sand;
c. providing water; and
d. mixing the-carbonated composite, the sand, and the water to form mortar.

20. The method according to claim 1, wherein the carbonated composite is a supplementary cementitious material.

21. A The method according to claim 20, wherein the supplementary cementitious material is a particulate.

22. The method according to claim 1, wherein step (c) comprises about 2 wt % to about 45 wt % mineral material.

23. A The method according to claim 1, wherein step (c) comprises about 0.01 wt % to about 3 wt % modifier, based on the weight of the particulate material.

24. (canceled)

25. (canceled)

26. (canceled)
